(19) United States
(12) Patent Application Publication
(10) Pub. No.: US 2023/0291999 A1
(43) Pub. Date: Sep. 14, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventors: YUGO SATO, TOKYO (JP); HARM CRONIE, LAUSANNE (CH); MATTHEW LAWRENSON, LAUSANNE (CH)

(21) Appl. No.: 18/003,763

(22) PCT Filed: May 27, 2021
(86) PCT No.: PCT/JP2021/020217

§ 371 Date: Dec. 29, 2022

(30) Foreign Application Priority Data
Jul. 7, 2020 (JP) 2020-116773

(51) Int. Cl. H04N 23/60; G06T 7/50; G06T 7/70; G06V 10/70

(52) U.S. Cl. CPC H04N 23/64; G06T 7/50; G06T 7/70; G06V 10/70; G06T 2207/30204; G06T 2207/10028

(57) ABSTRACT

Acquisition of a three-dimensional shape of an object by a user is efficiently supported. There is provided an information processing device including a control unit that controls presentation of feedback related to arrangement of a plurality of mirror surfaces arranged around an object to be imaged and used for acquiring a three-dimensional shape of the object. Furthermore, there is provided an information processing method including controlling, by a processor, presentation of feedback related to arrangement of a plurality of mirror surfaces arranged around an object to be imaged and used for acquiring a three-dimensional shape of the object.

### TECHNICAL FIELD

The present disclosure relates to an information processing device, an information processing method, and a program.

### BACKGROUND ART

In recent years, techniques for acquiring a three-dimensional shape of an object and using the three-dimensional shape for generating a three-dimensional model, product inspection, and the like have been developed. Furthermore, a method of efficiently acquiring a three-dimensional shape of an object has also been proposed. For example, Non Patent Document 1 describes a method of acquiring an entire peripheral shape of an object by one time of imaging by arranging mirror surfaces around the object to be imaged.

### CITATION LIST

### Patent Document

Non Patent Document 1: Ruilin Xu, 2 others, “Trapping Light for Time of Flight”, Jun. 18, 2019, [Online], [Searched on Jun. 17, 2020], Internet <https://ieeexplore.ieee.org/document/8578749>

### SUMMARY OF THE INVENTION

### Problems to be Solved by the Invention

With the technique described in Non Patent Document 1, it is possible to acquire the three-dimensional shape of the object with a simpler configuration. However, in a case of using the technique described in Non Patent Document 1, in order to acquire a three-dimensional shape with sufficient accuracy, it is required to strictly perform calibration regarding a positional relationship between a sensor and the mirror surfaces. Thus, it may be difficult for a general user who does not have specialized knowledge to use the above-described technique.

### Solutions to Problems

According to one aspect of the present disclosure, there is provided an information processing device including a control unit that controls presentation of feedback related to arrangement of a plurality of mirror surfaces arranged around an object to be imaged and used for acquiring a three-dimensional shape of the object.

Furthermore, according to another aspect of the present disclosure, there is provided an information processing method including controlling, by a processor, presentation of feedback related to arrangement of a plurality of mirror surfaces arranged around an object to be imaged and used for acquiring a three-dimensional shape of the object.

Furthermore, according to another aspect of the present disclosure, there is provided a program for causing a computer to function as an information processing device including a control unit that controls presentation of feedback related to arrangement of a plurality of mirror surfaces arranged around an object to be imaged and used for acquiring a three-dimensional shape of the object.

### BRIEF DESCRIPTION OF DRAWINGS

FIG. 1 is a diagram for describing an imaging method of an object O according to one embodiment of the present disclosure.

FIG. 2 is a block diagram illustrating a functional configuration example of an information processing device 10 according to the same embodiment.

FIG. 3 is a flowchart for describing a flow of feedback related to detection of mirror surfaces and arrangement of the mirror surfaces by the information processing device 10 according to the same embodiment.

FIG. 4 is a diagram for describing an example of image recognition according to the same embodiment.

FIG. 5 is a diagram illustrating a specific example of feedback related to arrangement of the mirror surfaces according to the same embodiment.

FIG. 6 is a diagram illustrating a specific example of the feedback related to arrangement of the mirror surfaces according to the same embodiment.

FIG. 7 is a diagram illustrating a specific example of the feedback related to arrangement of the mirror surfaces according to the same embodiment.

FIG. 8 is a flowchart illustrating an example of a flow of mirror surface detection according to the same embodiment.

FIG. 9 is a diagram for describing detection of a predetermined marker according to the same embodiment.

FIG. 10 is a diagram for describing detection of an outer shape of the information processing device 10 according to the same embodiment.

FIG. 11 is a diagram for describing a virtual try-on system using a three-dimensional shape of a body shape acquired by the information processing device 10 according to the same embodiment.

FIG. 12 is a block diagram illustrating a hardware configuration example of the information processing device 10 according to the same embodiment.

### MODE FOR CARRYING OUT THE INVENTION

Hereinafter, preferred embodiments of the present disclosure will be described in detail with reference to the accompanying drawings. Note that in the description and the drawings, components having substantially the same functional configuration are denoted by the same reference numerals, and redundant descriptions are omitted.

Note that the description will be made in the following order.

1. Embodiment
1.1. Background
1.2. Functional configuration example of information processing device 10
1.3. Functional Details
1.4.1.4. Application Example

2. Hardware configuration example

3. Summary

### 1. Embodiment

### 1.1. Background

As described above, in recent years, techniques for acquiring a three-dimensional shape of an object have been developed. In order to acquire the three-dimensional shape of an object with high accuracy, it is important to uniformly image the entire circumference of the object in order to prevent accuracy degradation due to occlusion.

However, in a normal method, it is difficult to image the entire circumference of the object by one time of imaging. Thus, for example, a method of arranging an object on a turntable and rotating the turntable to image the entire circumference of the object from one viewpoint, a method of imaging an object from a plurality of viewpoints and integrating measurement results, and the like are used.

However, the technique using the turntable as described above is, for example, not suitable for acquiring a three-dimensional shape of an object whose posture changes during rotation, such as a person. Furthermore, in the method of acquiring an object from a plurality of viewpoints as described above, strict calibration work regarding the viewpoint of the sensor is required in advance, and it takes time and effort to perform imaging.

Accordingly, for example, as described in Non Patent Document 1, a method of imaging the entire circumference of an object by one time of imaging by using mirror surfaces arranged around the object to be imaged has also been proposed.

In the technique described in Non Patent Document 1, a three-dimensional shape of an object is acquired by performing coordinate transformation related to a distance image captured on the basis of a position of a mirror surface. According to such a technique, it is possible to efficiently acquire the three-dimensional shape of the object with a simpler configuration.

However, the technique described in Non Patent Document 1 also requires strict calibration regarding a positional relationship between a sensor that images an object and the mirror surface. Thus, it is difficult for a user who does not have specialized knowledge to use the technique.

A technical idea according to one embodiment of the present disclosure has been conceived focusing on the above-described points, and enables efficient support of acquisition of a three-dimensional shape of an object by a user.

For this purpose, one of characteristics of an information processing device 10 according to the one embodiment of the present disclosure is to include a control unit 140 that controls presentation of feedback related to a plurality of mirror surfaces arranged around an object to be imaged and used for acquiring a three-dimensional shape of the object.

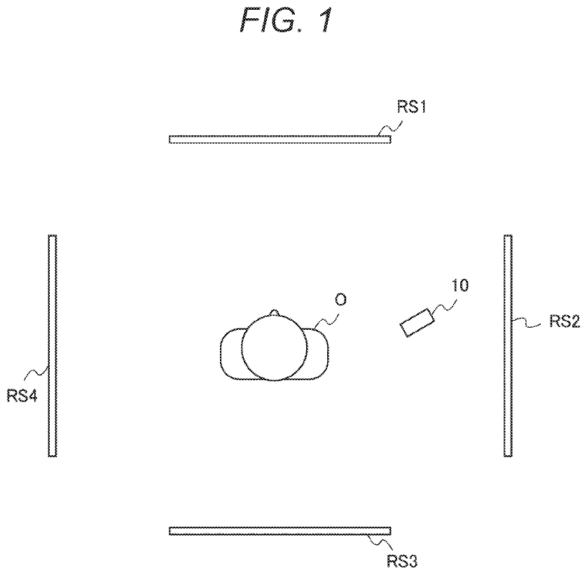

FIG. 1 is a diagram for describing an imaging method of an object O according to the one embodiment of the present disclosure. FIG. 1 simply illustrates an arrangement example of the object O, a plurality of mirror surfaces RS1 to RS4 arranged around the object O, and the information processing device 10 that images the object O reflected in the mirror surfaces RS1 to RS4.

In the example illustrated in FIG. 1, the object O may be a general user himself/herself who does not have specialized knowledge about acquisition of a three-dimensional shape.

Furthermore, the mirror surfaces RS1 to RS4 may be a full-length mirror or the like arranged by the user who is the object O. In order to acquire the three-dimensional shape of the user, the user who is the object O may arrange the mirror surfaces RS1 to RS4 around the user according to a tutorial or the like presented by the information processing device 10, for example.

However, at this time, it is difficult for a user who does not have specialized knowledge regarding acquisition of the three-dimensional shape to grasp the arrangement of the mirror surfaces RS1 to RS4 required to acquire a three-dimensional shape with sufficient accuracy and perform calibration based on positions of the mirror surfaces RS1 to RS4.

Thus, the information processing device 10 according to the present embodiment may detect a plurality of mirror surfaces RS arranged by the user and automatically execute calibration based on the arrangement of the plurality of detected mirror surfaces RS.

Furthermore, in a case where the arrangement of the plurality of detected mirror surfaces RS is not suitable for acquisition of a three-dimensional shape with sufficient accuracy, or the like, the information processing device 10 according to the present embodiment may present feedback for improving the arrangement of the plurality of mirror surfaces RS to the user.

According to the control as described above, the three-dimensional shape of the object O can be easily acquired by adjusting the arrangement of the mirror surfaces RS by the user who has received the feedback, or the like.

Hereinafter, a functional configuration example of the information processing device 10 that achieves the feedback as described above will be described in detail.

### 1.2. Functional Configuration Example of Information Processing Device 10

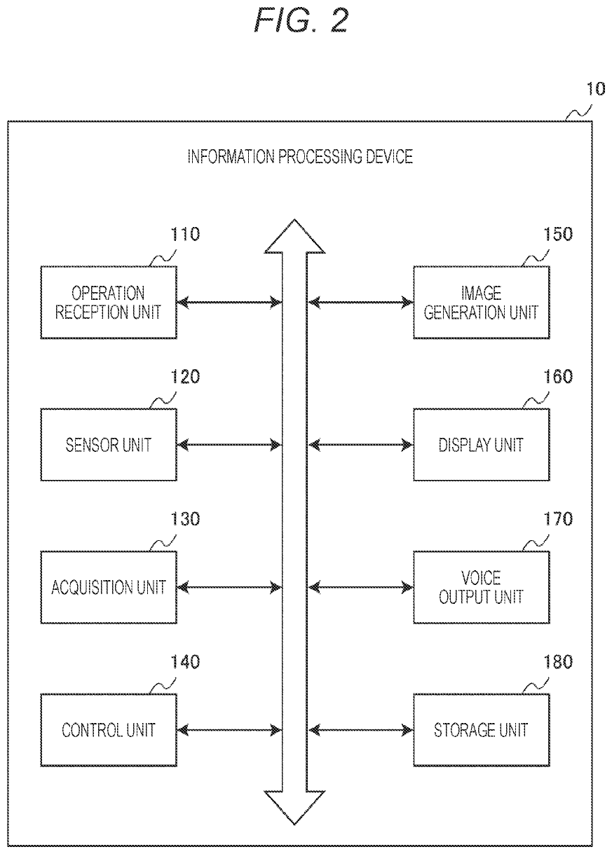

FIG. 2 is a block diagram illustrating the functional configuration example of the information processing device 10 according to the present embodiment. The information processing device 10 according to the present embodiment may be, for example, a general-purpose device having an imaging function, such as a smartphone or a tablet.

As illustrated in FIG. 2, the information processing device 10 according to the present embodiment may include an operation reception unit 110, a sensor unit 120, an acquisition unit 130, a control unit 140, an image generation unit 150, a display unit 160, a voice output unit 170, and a storage unit 180.

(Operation Reception Unit 110)

The operation reception unit 110 according to the present embodiment receives an operation by a user. For this purpose, the operation reception unit 110 according to the present embodiment includes a button, a switch, a touch panel, and the like.

(Sensor Unit 120)

The sensor unit 120 according to the present embodiment acquires an image with an object as a subject. In particular, one of the characteristics of the sensor unit 120 according to the present embodiment is to acquire an image in which the object reflected in mirror surfaces arranged around the object is set as a subject.

For this purpose, the sensor unit 120 according to the present embodiment includes an RGB camera, a ToF sensor, and the like. The sensor unit 120 according to the present embodiment may acquire an image by, for example, RGB cameras arranged on both of a front surface and a back surface of the information processing device 10 and the ToF sensor arranged on either the front surface or the back surface of the information processing device 10.

Note that the sensor unit 120 according to the present embodiment may acquire an image from a fixed viewpoint, for example, fixed by a tripod or the like. On the other hand, the sensor unit 120 according to the present embodiment may capture an image at a dynamically changing viewpoint such as being held in the hand of the user, for example. In this case, in order to track the dynamically changing viewpoint, the sensor unit 120 may further include an acceleration sensor, a gyro sensor, or the like.

(Acquisition Unit 130) The acquisition unit 130 according to the present embodiment detects a plurality of mirror surfaces arranged around the object, and acquires a three-dimensional shape of the object on the basis of an image obtained by imaging the object reflected in the mirror surfaces.

Functions of the acquisition unit 130 according to the present embodiment are implemented by various processors. Details of the functions of the acquisition unit 130 according to the present embodiment will be separately described.

(Control Unit 140)

The control unit 140 according to the present embodiment controls each component included in the information processing device 10. In particular, one of the characteristics of the control unit 140 according to the present embodiment is to control presentation of feedback related to a plurality of mirror surfaces arranged around an object to be imaged and used for acquiring a three-dimensional shape of the object.

At this time, the control unit 140 according to the present embodiment may perform control so that feedback related to the arrangement of the mirror surfaces that improves accuracy of the three-dimensional shape of the object acquired by the acquisition unit 130 is presented.

According to the above-described control by the control unit 140 according to the present embodiment, it is possible to efficiently support acquisition of the three-dimensional shape of the object by the user.

Functions of the control unit 140 according to the present embodiment are implemented by various processors. Details of the functions of the control unit 140 according to the present embodiment will be separately described.

(Image Generation Unit 150)

The image generation unit 150 according to the present embodiment generates an image on the basis of the three-dimensional shape of the object acquired by the acquisition unit 130.

Functions of the image generation unit 150 according to the present embodiment are implemented by various processors. Details of the functions of the image generation unit 150 according to the present embodiment will be separately described.

(Display Unit 160)

The display unit 160 according to the present embodiment is an example of a presentation unit that presents the feedback related to the arrangement of the mirror surfaces in accordance with control by the control unit 140. That is, the display unit 160 according to the present embodiment may present the above-described feedback of visual type to the user. For this purpose, the display unit 160 according to the present embodiment includes various displays.

(Voice Output Unit 170)

The voice output unit 170 according to the present embodiment is an example of the presentation unit that presents the feedback related to the arrangement of the mirror surfaces under the control of the control unit 140. That is, the voice output unit 170 according to the present embodiment may present the above-described feedback of auditory type to the user. For this purpose, the voice output unit 170 according to the present embodiment includes an amplifier, a speaker, and the like.

(Storage Unit 180)

The storage unit 180 according to the present embodiment stores information and the like used by each component included in the information processing device 10. For example, the storage unit 180 according to the present embodiment stores programs used by the acquisition unit 130, the control unit 140, and the image generation unit 150.

Furthermore, for example, the storage unit 180 according to the present embodiment stores an image captured by the sensor unit 120, a three-dimensional shape of an object acquired by the acquisition unit 130, various images generated by the image generation unit 150, and the like.

The functional configuration example of the information processing device 10 according to the present embodiment has been described above. Note that the functional configuration described above with reference to FIG. 2 is merely an example, and the functional configuration of the information processing device 10 according to the present embodiment is not limited to such an example.

The information processing device 10 according to the present embodiment may not necessarily include all of the components described above. For example, the information processing device 10 may perform only visual feedback by the display unit 160 without including the voice output unit 170.

In addition, the above-described functions may be implemented by cooperation of a plurality of devices. For example, the acquisition unit 130 may acquire the three-dimensional shape of the object on the basis of an image captured by a separate sensor device. Furthermore, for example, the control unit 140 may cause a separate presentation device to execute the feedback as described above. In this case, the control unit 140 may be arranged on a cloud. The functional configuration of the information processing device 10 according to the present embodiment can be flexibly modified according to specifications and operations.

### 1.3. Details of Functions

Next, functions of the information processing device 10 according to the present embodiment will be described in detail. First, a flow of feedback related to detection of mirror surfaces and arrangement of the mirror surfaces by the information processing device 10 according to the present embodiment will be described.

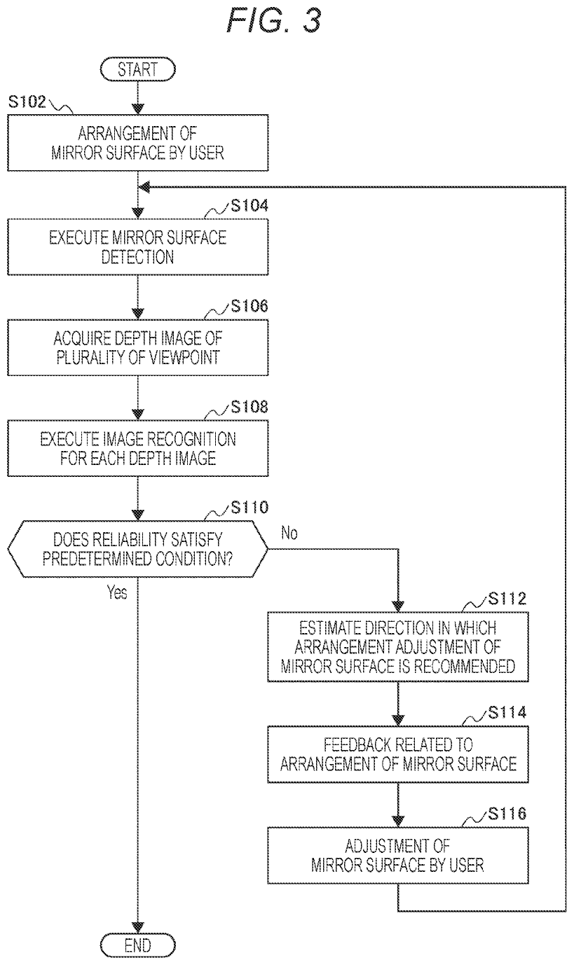

FIG. 3 is a flowchart for describing a flow of feedback related to detection of the mirror surfaces and arrangement of the mirror surfaces by the information processing device 10 according to the present embodiment.

As illustrated in FIG. 3, first, the mirror surface is arranged by the user (S102). At this time, the user may arrange the mirror surface according to a tutorial or the like displayed on the display unit 160, for example.

Next, mirror surface detection by the acquisition unit 130 is executed (S104). The method of mirror surface detection executed in step S104 will be separately described in detail.

Next, the sensor unit 120 acquires depth images of a plurality of viewpoints using mirror surfaces detected in step S104 (S106).

At this time, the number of viewpoints may be arbitrarily set. For example, the sensor unit 120 may acquire depth images of viewpoints set at equal intervals around the object.

Next, the acquisition unit 130 executes image recognition for each depth image acquired in step S106 (S108).

A result of the image recognition in step S108 is used for feedback control by the control unit 140. That is, the control unit 140 according to the present embodiment may control the feedback related to the arrangement of the mirror surface on the basis of the result of image recognition on the captured image.

This is based on characteristics that, in a case where quality of an input image (for example, a depth image acquired in step S106) is poor, image recognition accuracy by the acquisition unit 130 is deteriorated or reliability is estimated to be low.

The above-described image recognition includes, for example, pose estimation and surface model estimation related to an object.

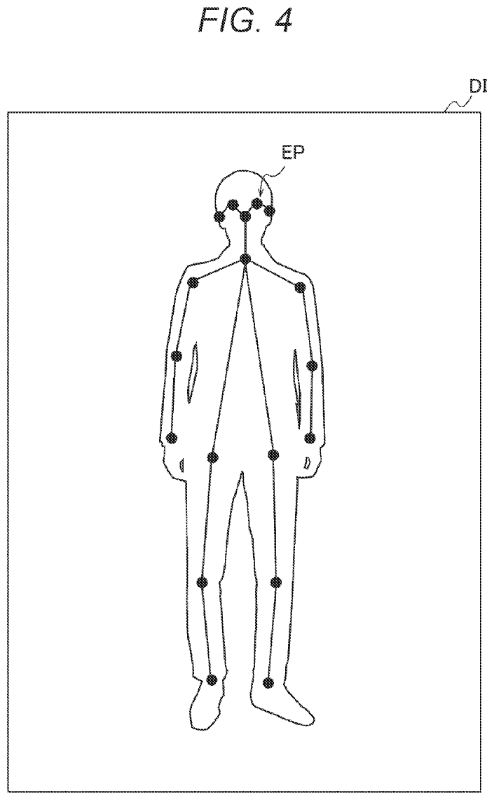

FIG. 4 is a diagram for describing an example of image recognition according to the present embodiment. FIG. 4 illustrates an example of pose information EP of the object estimated by the acquisition unit 130 on the basis of the input depth image DI.

For example, in a case where the object is a person, the pose information EP may include detection positions of main joints or main parts in the face (for example, a nose, an eye, and an ear), or the like of the person, and drawing information in which detected configurations are connected by lines.

Note that the acquisition unit 130 according to the present embodiment may perform pose estimation based on RGB images or surface model estimation, in addition to the pose estimation based on the depth image.

The acquisition unit 130 according to the present embodiment may execute the above-described image recognition using a machine learning method such as convolutional neural network (CNN), for example.

The acquisition unit 130 can obtain an estimation result (for example, the pose information illustrated in FIG. 4) and reliability related to the estimation result as outputs by inputting an image to a recognition device generated by learning.

On the other hand, the method of image recognition by the acquisition unit 130 is not limited to the examples described above, and may be another method capable of estimating the three-dimensional shape of the object.

The description will be continued again with reference to FIG. 3.

After the image recognition by the acquisition unit 130 is executed in step S108, the control unit 140 determines whether or not reliability related to the image recognition satisfies a predetermined condition (S110).

The above-described predetermined condition may be, for example, that the average of the reliability at all the viewpoints is higher than a threshold and a variance is smaller than a threshold.

Furthermore, the above-described predetermined condition may be, for example, that a minimum value of the reliability at all the viewpoints is higher than a threshold.

Furthermore, the above-described predetermined condition may be, for example, that a difference between the minimum value and a maximum value of the reliability at all the viewpoints is smaller than the threshold.

In a case where the reliability related to the image recognition satisfies the predetermined condition as described above (S110: Yes), the information processing device 10 ends the processing related to the feedback related to the detection of the mirror surfaces and the arrangement of the mirror surfaces.

On the other hand, in a case where the reliability related to the image recognition does not satisfy the predetermined condition as described above (S110: No), the control unit 140 according to the present embodiment estimates the direction in which the arrangement adjustment of the mirror surfaces is recommended (S112).

At this time, for example, the control unit 140 may estimate a direction in which the reliability is the lowest among all the viewpoints as the direction in which the adjustment of the mirror surface is recommended, or may estimate a direction of the viewpoint greatly deviating from the average reliability of all the viewpoints as the direction in which the adjustment of the mirror surface is recommended.

Next, the control unit 140 according to the present embodiment controls presentation of the feedback related to the arrangement of the mirror surface on the basis of an estimation result in step S112 (S114).

Next, the mirror surface is adjusted by the user on the basis of the feedback presented in step S114 (S116).

After the mirror surface is adjusted in S116, the information processing device 10 may return to step S104 and repeatedly execute the subsequent processing.

An example of the flow of feedback related to the detection of the mirror surfaces and the arrangement of the mirror surfaces by the information processing device 10 according to the present embodiment has been described above.

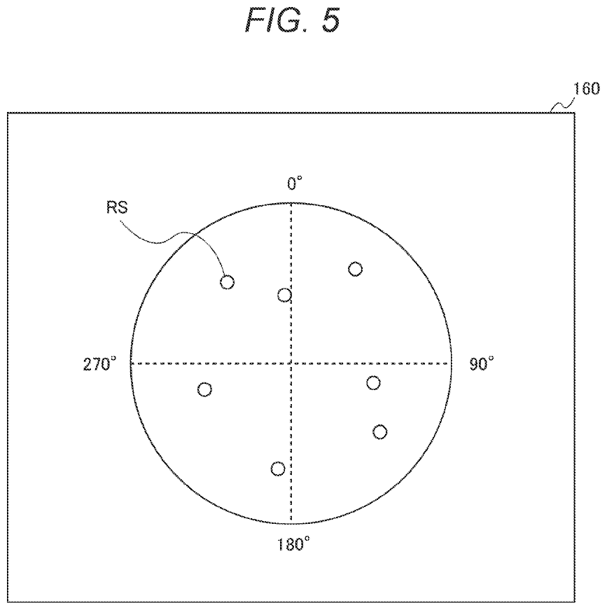

Next, the feedback according to the present embodiment will be described with a specific example. FIGS. 5 to 7 are diagrams illustrating specific examples of feedback related to the arrangement of the mirror surfaces according to the present embodiment. FIGS. 5 to 7 illustrate specific examples of visual feedback displayed by the display unit 160 under the control of the control unit 140.

For example, as in the example illustrated in FIG. 5, the control unit 140 may cause the display unit 160 to display visual feedback indicating positions and directions of the plurality of detected mirror surfaces RS.

For example, the control unit 140 may cause the display unit 160 to display an image obtained by plotting the positions and directions of the mirror surfaces detected within a predetermined range centered on the object or the information processing device 10.

Note that, in FIGS. 5 to 7, a dotted intersection indicates the position of the object or the information processing device 10, and white circles plotted on a region at a predetermined distance from the dotted intersection respectively indicate the mirror surfaces RS.

Furthermore, the control unit 140 may cause a message such as “Please adjust the positions so that the mirrors are uniformly arranged in respective directions” to be output together with an image as illustrated in FIG. 5 using characters or voice.

According to such feedback, the user can predict a direction in which the mirror surfaces RS is insufficient on the basis of the distribution of the mirror surfaces RS, and it is possible to perform arrangement adjustment of the mirror surfaces RS on the basis of the prediction.

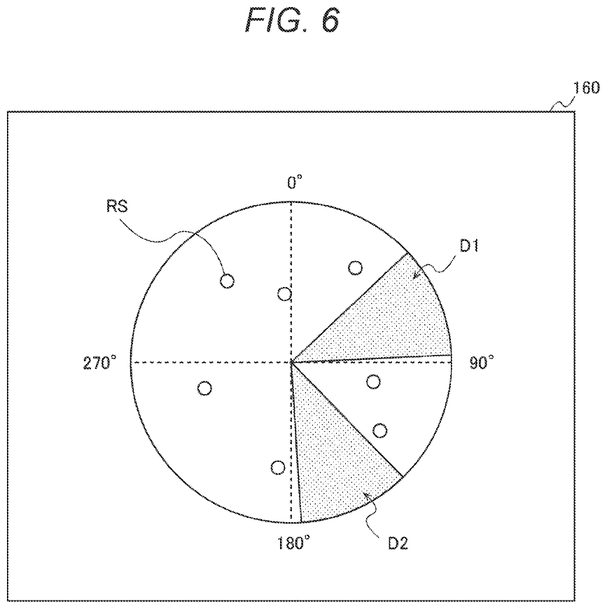

Furthermore, as in the example illustrated in FIG. 6, the control unit 140 according to the present embodiment may cause the display unit 160 to display visual feedback specifically indicating the direction in which the arrangement adjustment of the mirror surfaces RS is recommended.

In the case of the example illustrated in FIG. 6, the control unit 140 causes the display unit 160 to display an image in which the directions D1 and D2 in which the arrangement adjustment of the mirror surfaces RS is recommended are emphasized.

Furthermore, the control unit 140 may cause a message such as “Please add a mirror in direction indicated by the image, or move nearby mirror in that direction” to be output together with the image as illustrated in FIG. 6 using characters or voice.

According to such feedback, the user can intuitively grasp the direction in which the mirror surfaces RS is insufficient, and can more efficiently perform arrangement adjustment of the mirror surfaces RS.

Furthermore, the control unit 140 according to the present embodiment may control presentation of feedback indicating recommended positions of the mirror surfaces RS or feedback designating the mirror surface RS that is recommended to be moved.

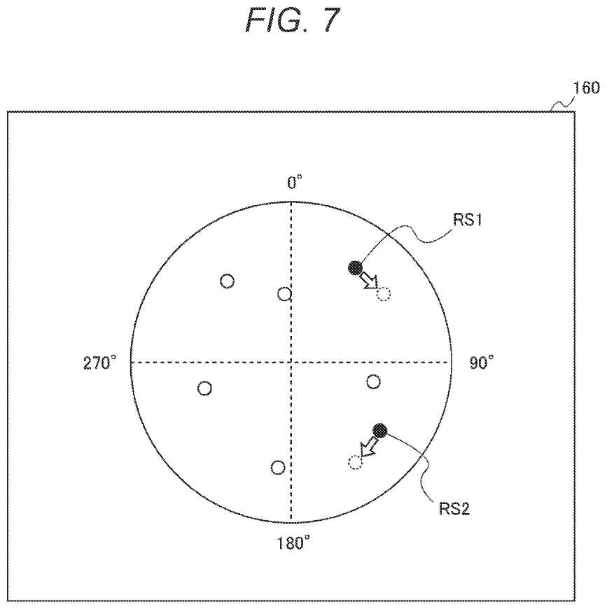

In the case of the example illustrated in FIG. 7, the control unit 140 designates the mirror surfaces RS1 and RS, and displays respective recommended movement positions (position after recommended rearrangement) on the display unit 160 using arrows and the like.

In addition, the control unit 140 may output a message such as “Please adjust the position of the corresponding mirror with reference to the image” together with an image as illustrated in FIG. 7 using characters or voice.

According to such feedback, the user can more effectively rearrange the mirror surfaces RS, and it is possible to easily acquire the three-dimensional shape of the object with high accuracy.

The feedback according to the present embodiment has been described above with specific examples. Note that the mode of the feedback illustrated using FIGS. 5 to 7 is merely an example, and the feedback according to the present embodiment is not limited to such an example.

For example, the feedback related to the arrangement of the mirror surfaces is not limited to those accompanied with visual information, and may include only auditory information. For example, the control unit 140 may cause the voice output unit 170 to output a voice such as “Please add a mirror in the 7:00 direction”. Even in this case, the user can effectively reposition the mirror surface on the basis of auditory feedback.

Next, mirror surface detection by the acquisition unit 130 according to the present embodiment will be described in detail. In order to accurately achieve the feedback as described above, it is important to accurately detect mirror surfaces existing around the object.

For this purpose, the acquisition unit 130 according to the present embodiment may detect the mirror surfaces on the basis of, for example, a predetermined pattern included in the acquired image.

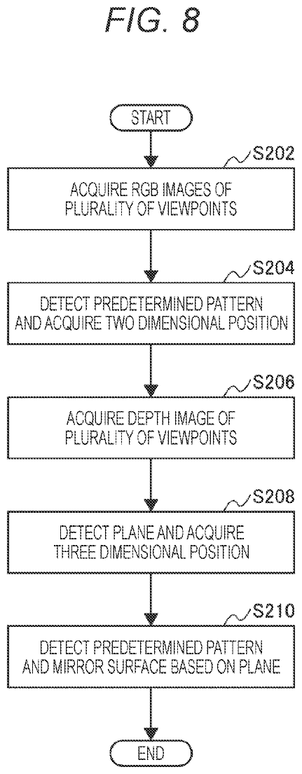

FIG. 8 is a flowchart illustrating an example of a flow of mirror surface detection according to the present embodiment. In the mirror surface detection according to the present embodiment, first, RGB images of a plurality of viewpoints are acquired by the sensor unit 120 (S202).

At this time, the sensor unit 120 may acquire RGB images of a plurality of viewpoints by using, for example, RGB cameras arranged on the front surface and the back surface of the information processing device 10 or an omnidirectional camera.

Next, the acquisition unit 130 performs pattern matching on the RGB images of the plurality of viewpoints acquired in step S202, detects a predetermined pattern included in the RGB image, and acquires a two-dimensional position of the detected predetermined pattern. (S204).

The predetermined pattern according to the present embodiment includes, for example, a predetermined marker displayed on the display unit 160. In this case, the acquisition unit 130 according to the present embodiment may detect the mirror surface on the basis of a predetermined marker included in the acquired image.

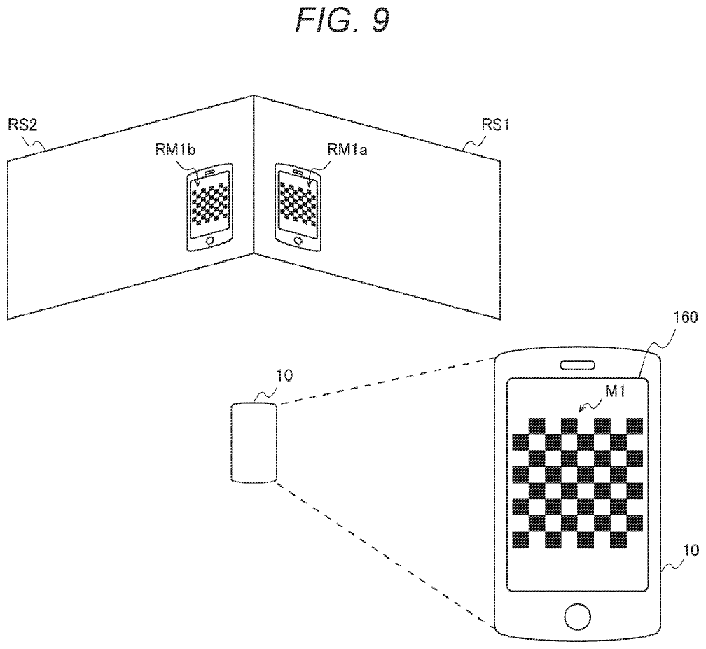

FIG. 9 is a diagram for describing detection of a predetermined marker according to the present embodiment. FIG. 9 exemplifies an arrangement relationship between the information processing device 10 and the mirror surfaces RS1 and RS2. In the example illustrated in FIG. 9, the front surface of the information processing device 10 and the mirror surfaces RS1 and RS2 are arranged to face each other.

Furthermore, in the example illustrated in FIG. 9, a predetermined marker M1 is displayed on the display unit 160 arranged in front of the information processing device 10. In this case, mirror images RM1a and RM1b related to the predetermined marker M1 are respectively reflected in the mirror surfaces RS1 and RS2.

Thus, the acquisition unit 130 according to the present embodiment may perform pattern matching on RGB images acquired in step S204 and estimate that the mirror surface RS is present at the two-dimensional position where the predetermined marker M1 registered in advance is detected.

According to the processing as described above, it is possible to detect the mirror surfaces RS arranged around the object with high accuracy.

Note that, in FIG. 9, the case where the predetermined marker is a check-like design has been exemplified, but the predetermined marker according to the present embodiment may be any design as long as it is unlikely to be present in the imaging environment.

Furthermore, the predetermined pattern according to the present embodiment includes, for example, an outer shape of the information processing device 10. In this case, the acquisition unit 130 according to the present embodiment may detect the mirror surfaces on the basis of the outer shape of the information processing device 10 included in the acquired image.

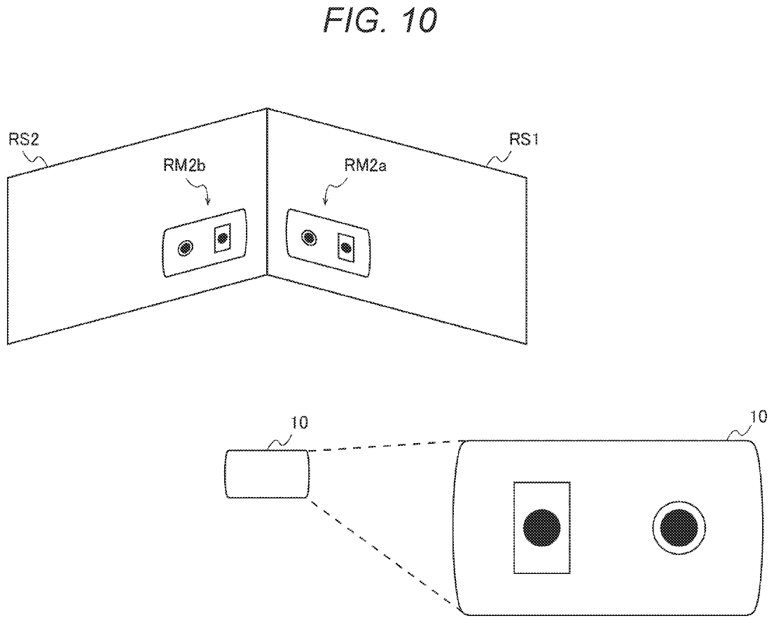

FIG. 10 is a diagram for describing detection of the outer shape of the information processing device 10 according to the present embodiment. FIG. 10 exemplifies an arrangement relationship between the information processing device 10 and the mirror surfaces RS1 and RS2. In the example illustrated in FIG. 9, the information processing device 10 and the mirror surfaces RS1 and RS2 are arranged to face each other.

In this case, mirror images RM2a and RM2b relating to the outer shape of the information processing device 10 on the side facing the mirror surfaces are respectively reflected in the mirror surfaces RS1 and RS2.

From this point, the acquisition unit 130 according to the present embodiment may perform pattern matching on the RGB images acquired in step S204 and estimate that the mirror surface RS exists at the two-dimensional position where the outer shape of the information processing device 10 is detected.

According to the processing as described above, it is possible to detect the mirror surfaces RS arranged around the object with high accuracy without separately facilitating the marker or the like.

Note that the acquisition unit 130 may perform pattern matching as described above using various methods widely used in the field of image recognition. Examples of the above-described method include a method using a feature amount such as SIFT or SURF, and a method using deep learning or the like.

The description will be continued again with reference to FIG. 8.

When the detection of the predetermined pattern and the acquisition of the two-dimensional position of the predetermined pattern in step S204 are completed, the sensor unit 120 acquires depth images of a plurality of viewpoints (S206).

At this time, the sensor unit 120 may acquire the depth images on the basis of a measurement value of the ToF sensor. On the other hand, the depth images estimated from the RGB images captured by the RGB cameras may be acquired. In this case, the sensor unit 120 can estimate the depth images by using, for example, an estimator or the like generated by learning that uses an RGB image as an input and outputs a depth image.

Next, the acquisition unit 130 executes plane detection on the depth images acquired in step S206 and acquires a three-dimensional position of a detected plane (S208).

At this time, in a case where a plurality of planes is detected, the acquisition unit 130 may acquire a three-dimensional position of each plane.

Furthermore, the acquisition unit 130 may perform plane detection using various methods widely used in the field of image recognition. Examples of the above-described method include a method using a three-dimensional Hough transform, or the like.

Next, the acquisition unit 130 according to the present embodiment detects the mirror surfaces on the basis of the predetermined pattern detected in step S204 and the plane detected in step S208 (S210).

More specifically, the acquisition unit 130 may detect a region where the two-dimensional position where the predetermined pattern is detected and the three-dimensional position where the plane is detected overlap each other as a mirror surface. That is, the acquisition unit 130 may detect a region in which the predetermined pattern is reflected and which is detected as a plane as a mirror surface.

According to the processing as described above, the mirror surfaces existing around the object can be detected with high accuracy by combining the detection of the predetermined pattern and the plane detection.

On the other hand, the above-described processing described with reference to FIG. 8 is merely an example, and the method of mirror surface detection according to the present embodiment is not limited to such an example.

For example, it is known that a result of distance measurement by the ToF sensor causes a distortion due to the material of the object. Thus, the acquisition unit 130 can detect the mirror surface by using, for example, an estimator that has learned the distortion caused by the mirror surface.

### 1.4. Application Example

Next, an application example of using the three-dimensional shape of the object acquired by the information processing device 10 according to the present embodiment will be described with an example. As described above, according to the information processing device 10 according to the present embodiment, even a user who does not have specialized knowledge can easily acquire a three-dimensional shape of an object.

Furthermore, the information processing device 10 according to the present embodiment can be achieved as a general-purpose device such as a smartphone or a tablet. Thus, the user can enjoy various services using the three-dimensional shape of the object by using the device as described above.

For example, the obtained three-dimensional shape of the object may be used for services such as e-commerce. More specifically, the user may be able to acquire the three-dimensional shape of the user himself/herself, and search for a ready-made product suitable for the user's body shape or order the ready-made product to order. Furthermore, the user may be able to receive a recommendation of a product matching his/her body shape, or the like.

As described above, according to the information processing device 10 according to the present embodiment, for example, it is possible to acquire a highly accurate three-dimensional shape without requiring a complicated and large-scale system such as attaching a dedicated sensor to the body of the user.

Thus, the user can easily use the service as described above only by preparing the information processing device 10 achieved as a smartphone, a mirror, and the like and performing imaging in the environment as illustrated in FIG. 1.

Furthermore, the three-dimensional shape of the body shape acquired by the information processing device 10 according to the present embodiment may be used in, for example, a virtual try-on system.

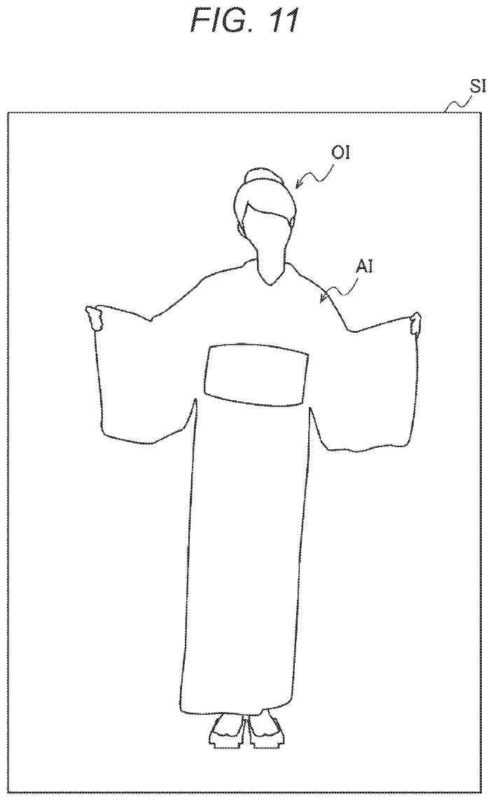

FIG. 11 is a diagram for describing a virtual try-on system using the three-dimensional shape of the body shape acquired by the information processing device 10 according to the present embodiment.

FIG. 11 illustrates an example of a composite image SI generated by the image generation unit 150 on the basis of the three-dimensional shape of the body shape of the user acquired by the acquisition unit 130. As illustrated in FIG. 11, the image generation unit 150 according to the present embodiment may generate the composite image SI including an object image CI generated on the basis of the three-dimensional shape of the body shape and a superimposed image AI related to a product such as clothes matching the shape of the object image OI.

The image generation unit 150 according to the present embodiment may generate the composite image SI by superimposing the superimposed image AI generated in accordance with the shape of the object image OI on the object image OI generated by the acquisition unit 130 by the surface model estimation.

On the other hand, the image generation unit 150 according to the present embodiment may generate the object image OI that is the human-shaped CG on the basis of the three-dimensional shape of the body shape acquired by the acquisition unit 130, and generate the composite image SI by superimposing the superimposed image AI generated in accordance with the shape of the object image OI.

According to the processing as described above, the user can virtually try on a favorite product while staying at home and purchase a product suitable for the user.

Note that, although clothes have been described above as an example of the product, the image generation unit 150 may generate the composite image SI including the superimposed image AI regarding the product to be worn on a part of the body such as a hat or shoes, for example.

In this case, it is sufficient for the user to prepare a mirror (for example, a tabletop mirror or the like) having a sufficient size to reflect a part of the head, the foot, or the like and perform imaging, and it is possible to more easily use the service.

Furthermore, in the above description, a service such as e-commerce has been described as an application example of using the three-dimensional shape of the acquired object, but the application range of the technology according to the present embodiment is not limited to such an example.

The three-dimensional shape of the object acquired by the information processing device 10 according to the present embodiment may be used for generating an avatar used in a computer field such as a game or an SNS, for example. In this case, the user can easily generate an avatar similar to an object (for example, the user himself/herself) without complicated work.

In addition to the above, the three-dimensional shape of the object acquired by the information processing device 10 according to the present embodiment can be used, for example, for creation of various video content including computer graphics (CG) and still image content. In this case, it is possible to effectively reduce the cost required to create the content.

Furthermore, the three-dimensional shape of the object acquired by the information processing device 10 according to the present embodiment may be used for generation of learning data in the machine learning field. In this case, a large amount of learning data can be easily secured, and highly accurate learning can be achieved.

As described above, the three-dimensional shape of the object acquired by the information processing device 10 according to the present embodiment can be widely used in various fields.

Note that, in the above description, the case where the object according to the present embodiment is mainly a person has been described. However, the object according to the present embodiment is not limited to such an example. The object according to the present embodiment may be any object such as various dynamic objects (objects that move) including a person, static objects (objects that do not move), or a part of a dynamic object or a static object.

### 2. Hardware Configuration Example

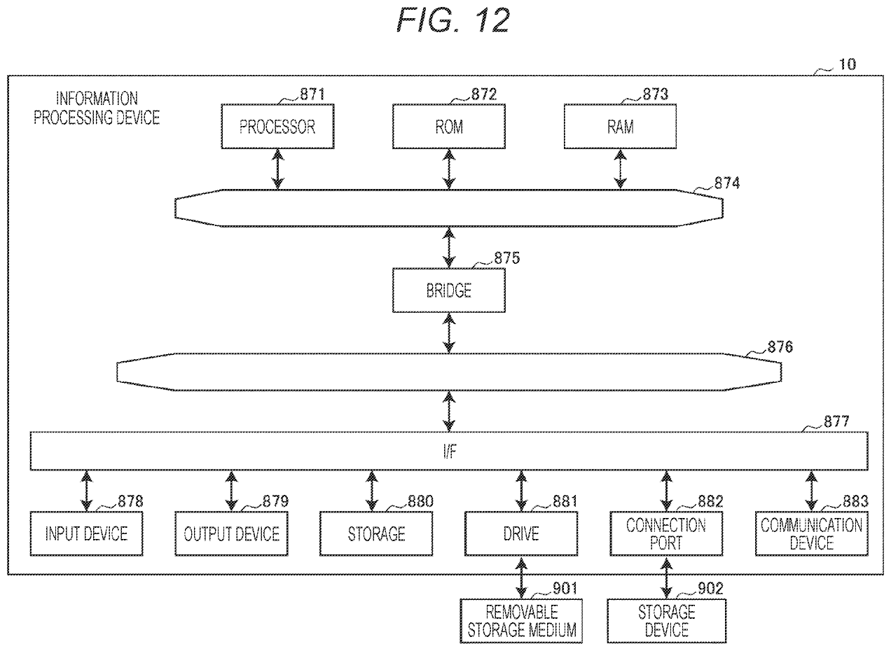

Next, a hardware configuration example of the information processing device 10 according to the one embodiment of the present disclosure will be described. FIG. 12 is a block diagram illustrating a hardware configuration example of the information processing device 10 according to the one embodiment of the present disclosure. As illustrated in FIG. 12, the information processing device 10 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. Furthermore, components other than the components illustrated here may be further included.

(Processor 871)

The processor 871 functions as, for example, an arithmetic processing device or a control device, and controls the overall operation of each component or a part thereof on the basis of various programs recorded in the ROM 872, the RAM 873, the storage 880, or a removable storage medium 901.

(ROM 872, RAM 873)

The ROM 872 is a unit that stores a program read by the processor 871, data used for calculation, and the like. The RAM 873 temporarily or permanently stores, for example, a program read by the processor 871, various parameters that appropriately change when the program is executed, and the like.

(Host Bus 874, Bridge 875, External Bus 876, and Interface 877)

The processor 871, the ROM 872, and the RAM 873 are mutually connected via, for example, the host bus 874 capable of high-speed data transmission. On the other hand, the host bus 874 is connected to the external bus 876 having a relatively low data transmission speed via the bridge 875, for example. Furthermore, the external bus 876 is connected to various components via the interface 877.

(Input Device 878)

As the input device 878, for example, a mouse, a keyboard, a touch panel, a button, a switch, a lever, and the like are used. Moreover, as the input device 878, a remote controller (hereinafter, remote controller) capable of transmitting a control signal using infrared rays or other radio waves may be used. Furthermore, the input device 878 includes a voice input device such as a microphone.

(Output Device 879)

The output device 879 is a device capable of visually or audibly notifying the user of acquired information, such as a display device such as a cathode ray tube (CRT), an LCD, or an organic EL, an audio output device such as a speaker or a headphone, a printer, a mobile phone, or a facsimile, for example. Furthermore, the output device 879 according to the present disclosure includes various vibration devices capable of outputting tactile stimulation.

(Storage 880)

The storage 880 is a device for storing various data. As the storage 880, for example, a magnetic storage device such as a hard disk drive (HDD), a semiconductor storage device, an optical storage device, a magneto-optical storage device, or the like is used.

(Drive 881)

The drive 881 is, for example, a device that reads information recorded on the removable storage medium 901 such as a magnetic disk, an optical disk, a magneto-optical disk, or a semiconductor memory, or writes information on the removable storage medium 901.

(Removable Storage Medium 901)

The removable storage medium 901 is, for example, a DVD medium, a Blu-ray (registered trademark) medium, an HD DVD medium, various semiconductor storage media, or the like. Of course, the removable storage medium 901 may be, for example, an IC card on which a non-contact IC chip is mounted, an electronic device, or the like.

(Connection Port 882)

The connection port 882 is a port for connecting an external connection device 902 such as a universal serial bus (USB) port, an IEEE 1394 port, a small computer system interface (SCSI), an RS-232C port, or an optical audio terminal, for example.

(External Connection Device 902)

The external connection device 902 is, for example, a printer, a portable music player, a digital camera, a digital video camera, an IC recorder, or the like.

(Communication Device 883)

The communication device 883 is a communication device for connecting to a network, for example, a wired or wireless LAN, Bluetooth (registered trademark), or a communication card for Wireless USB (WUSB), a router for optical communication, a router for Asymmetric Digital Subscriber Line (ADSL), or a modem for various communications, or the like.

### 3. Summary

As described above, one of the characteristics of the information processing device 10 according to the one embodiment of the present disclosure is to include the control unit 140 that controls presentation of feedback related to a plurality of mirror surfaces arranged around an object to be imaged and used for acquiring a three-dimensional shape of the object.

According to the above-described configuration, it is possible to efficiently support the acquisition of the three-dimensional shape of the object by the user.

The preferred embodiments of the present disclosure have been described above in detail with reference to the accompanying drawings, but the technical scope of the present disclosure is not limited to such examples. It is apparent that a person having ordinary knowledge in the technical field of the present disclosure can devise various change examples or modification examples within the scope of the technical idea described in the claims, and it will be naturally understood that they also belong to the technical scope of the present disclosure.

Furthermore, each step related to the processing described in the present description is not necessarily processed in time series in the order described in the flowchart or the sequence diagram. For example, each step related to the processing of each device may be processed in an order different from the described order or may be processed in parallel.

In addition, the series of processes performed by each device described in the present description may be achieved using any of software, hardware, and a combination of software and hardware. The program configuring the software is stored in advance in a storage medium (non-transitory medium) provided inside or outside each device, for example. Then, each program is read into the RAM at the time of execution by the computer, for example, and is executed by various processors. The storage medium is, for example, a magnetic disk, an optical disk, a magneto-optical disk, a flash memory, or the like. Furthermore, the computer program described above may be distributed via, for example, a network without using a storage medium.

Furthermore, the effects described in the present description are merely illustrative or exemplary and are not limited. That is, the technology according to the present disclosure can exhibit other effects that are apparent to those skilled in the art from the present description in addition to or instead of the effects described above.

Note that configurations as follows also belong to the technical scope of the present disclosure.

(1)

An information processing device including
a control unit that controls presentation of feedback related to arrangement of a plurality of mirror surfaces arranged around an object to be imaged and used for acquiring a three-dimensional shape of the object.

(2)

The information processing device according to (1), in which
the control unit controls presentation of feedback indicating positions and directions of a plurality of the mirror surfaces detected.

(3)

The information processing device according to (1) or (2), in which
the control unit controls presentation of feedback related to arrangement of the mirror surfaces for improving accuracy of the three-dimensional shape of the object to be acquired.

(4)

The information processing device according to (2), in which
the control unit controls presentation of feedback indicating a direction in which arrangement adjustment of the mirror surfaces is recommended.

(5) The information processing device according to (4), in which
the control unit controls presentation of feedback indicating recommended positions of the mirror surfaces.

(6)

The information processing device according to (5), in which
the control unit controls presentation of feedback designating the mirror surface that is recommended to be moved.

(7)

The information processing device according to any one of (1) to (6), in which
the control unit controls feedback related to arrangement of the mirror surfaces on the basis of a result of image recognition for the acquired image.

(8)

The information processing device according to (7), in which
the control unit estimates a direction in which arrangement adjustment of the mirror surfaces is recommended on the basis of the result of the image recognition.

(9)

The information processing device according to (7) or (8), in which
the image recognition includes pose estimation or surface model estimation regarding the object.

(10)

The information processing device according to any one of (1) to (9), further including

an acquisition unit that detects a plurality of the mirror surfaces and acquires a three-dimensional shape of the object on the basis of an image in which the object reflected in the mirror surfaces is set as a subject.

(11)

The information processing device according to (10), in which
the acquisition unit detects the mirror surfaces on the basis of a predetermined pattern included in the acquired image.

(12)

The information processing device according to (10), in which
the acquisition unit executes plane detection on the acquired image and detects the mirror surfaces on the basis of the detected plane.

(13)

The information processing device according to (11), in which the acquisition unit detects the mirror surfaces on the basis of the predetermined pattern detected and a plane.

(14)

The information processing device according to (11) or (13), in which
the predetermined pattern includes a predetermined marker displayed on a display unit, and
the acquisition unit detects the mirror surfaces on the basis of the predetermined marker included in an acquired image.

(15)

The information processing device according to (11) or (13), in which
the predetermined pattern includes an outer shape of the information processing device, and
the acquisition unit detects the mirror surfaces on the basis of an outer shape of the information processing device included in an acquired image.

(16)

The information processing device according to any one of (1) to (15), further including
a presentation unit that presents feedback related to arrangement of the mirror surfaces according to control by the control unit.

(17)

The information processing device according to any one of (1) to (16), further including
a sensor unit that acquires an image in which the object reflected in the mirror surfaces is set as a subject.

(18)

The information processing device according to any one of (1) to (17), further including
an image generation unit that generates an image on the basis of an acquired three-dimensional shape of the object.

(19)

An information processing method including
controlling, by a processor, presentation of feedback related to arrangement of a plurality of mirror surfaces arranged around an object to be imaged and used for acquiring a three-dimensional shape of the object.

(20)

A program for causing a computer to function as
an information processing device including
a control unit that controls presentation of feedback related to arrangement of a plurality of mirror surfaces arranged around an object to be imaged and used for acquiring a three-dimensional shape of the object.

### REFERENCE SIGNS LIST

10 Information processing device
110 Operation reception unit
120 Sensor unit
130 Acquisition unit
140 Control unit
150 Image generation unit
160 Display unit
170 Voice output unit
180 Storage unit

1. An information processing device comprising
a control unit that controls presentation of feedback related to arrangement of a plurality of mirror surfaces arranged around an object to be imaged and used for acquiring a three-dimensional shape of the object.

2. The information processing device according to claim 1, wherein
the control unit controls presentation of feedback indicating positions and directions of a plurality of the mirror surfaces detected.

3. The information processing device according to claim 1, wherein
the control unit controls presentation of feedback related to arrangement of the mirror surfaces for improving accuracy of the three-dimensional shape of the object to be acquired.

4. The information processing device according to claim 2, wherein
the control unit controls presentation of feedback indicating a direction in which arrangement adjustment of the mirror surfaces is recommended.

5. The information processing device according to claim 4, wherein
the control unit controls presentation of feedback indicating recommended positions of the mirror surfaces.

6. The information processing device according to claim 5, wherein
the control unit controls presentation of feedback designating the mirror surface that is recommended to be moved.

7. The information processing device according to claim 1, wherein
the control unit controls feedback related to arrangement of the mirror surfaces on a basis of a result of image recognition for the acquired image.

8. The information processing device according to claim 7, wherein
the control unit estimates a direction in which arrangement adjustment of the mirror surfaces is recommended on a basis of the result of the image recognition.

9. The information processing device according to claim 7, wherein
the image recognition includes pose estimation or surface model estimation regarding the object.

10. The information processing device according to claim 1, further comprising
an acquisition unit that detects a plurality of the mirror surfaces and acquires a three-dimensional shape of the object on a basis of an image in which the object reflected in the mirror surfaces is set as a subject.

11. The information processing device according to claim 10, wherein
the acquisition unit detects the mirror surfaces on a basis of a predetermined pattern included in the acquired image.

12. The information processing device according to claim 10, wherein
the acquisition unit executes plane detection on the acquired image and detects the mirror surfaces on a basis of the detected plane.

13. The information processing device according to claim 11, wherein the acquisition unit detects the mirror surfaces on a basis of the predetermined pattern detected and a plane.

14. The information processing device according to claim 11, wherein
the predetermined pattern includes a predetermined marker displayed on a display unit, and
the acquisition unit detects the mirror surfaces on a basis of the predetermined marker included in an acquired image.

15. The information processing device according to claim 11, wherein
the predetermined pattern includes an outer shape of the information processing device, and
the acquisition unit detects the mirror surfaces on a basis of an outer shape of the information processing device included in an acquired image.

16. The information processing device according to claim 1, further comprising
a presentation unit that presents feedback related to arrangement of the mirror surfaces according to control by the control unit.

17. The information processing device according to claim 1, further comprising
a sensor unit that acquires an image in which the object reflected in the mirror surfaces is set as a subject.

18. The information processing device according to claim 1, further comprising
an image generation unit that generates an image on a basis of an acquired three-dimensional shape of the object.

19. An information processing method comprising
controlling, by a processor, presentation of feedback related to arrangement of a plurality of mirror surfaces arranged around an object to be imaged and used for acquiring a three-dimensional shape of the object.

20. A program for causing a computer to function as
an information processing device including
a control unit that controls presentation of feedback related to arrangement of a plurality of mirror surfaces arranged around an object to be imaged and used for acquiring a three-dimensional shape of the object.
